(19) United States
(12) Patent Application Publication
(10) Pub. No.: US 2014/0317573 A1
(43) Pub. Date: Oct. 23, 2014

(54) DISPLAY APPARATUS AND METHOD OF DISPLAYING A CONTEXT MENU

(71) Applicant: SAMSUNG ELECTRONICS CO., LTD., Suwon-si (KR)

(72) Inventors: Su-gyeong HYEON, Daegu (KR); Min-sun PARK, Seoul (KR); Bong-hyun CHO, Suwon-si (KR)

(73) Assignee: SAMSUNG ELECTRONICS CO., LTD., Suwon-si (KR)

(21) Appl. No.: 14/255,347

(22) Filed: Apr. 17, 2014

Related U.S. Application Data
(60) Provisional application No. 61/812,882, filed on Apr. 17, 2013.

(30) Foreign Application Priority Data
Mar. 13, 2014 (KR) 10-2014-0029815

(51) Int. Cl. G06F 3/0482; G06F 3/0481

(52) U.S. Cl. CPC G06F 3/0482; G06F 3/04817
USPC 715/835

(57) ABSTRACT

A method of displaying a context menu of a display apparatus is provided. The method includes displaying a content list including at least one menu; displaying a menu identification icon that indicates on a menu of the at least one menu the existence of the context menu; and in response to any one menu of the at least one menu being focused, displaying the at least one context menu included in a focused menu. The context menu is a menu for at least one function that can be performed in relation to the menu of the at least one menu.

### CROSS REFERENCE TO RELATED APPLICATIONS

This application claims priority from Korean Patent Application No. 10-2014-0029815, filed on Mar. 13, 2014, in the Korean Intellectual Property Office, and claims benefit under 35 U.S.C. §119(a) from U.S. Provisional Application No. 61/812,882, filed on Apr. 17, 2013, in the United States Patents and Trademark Office, the disclosures of which is incorporated herein by reference, in their entireties.

### BACKGROUND

1. Technical Field

Apparatuses and methods consistent with the exemplary embodiments relate to a display apparatus and a method of displaying a context menu. More particularly, the exemplary embodiments relate to a display apparatus and a method of displaying a context menu on a screen, which can display a context menu that a user can easily recognize.

2. Description of the Related Art

As display devices such as TVs are large-sized and have multiple functions, users can use various kinds of content or applications in addition to viewing images using the display devices.

For example, a user can execute social network services, such as Twitter and Kakao Talk, and other various kinds of content using a display device connected to the Internet.

In the case of executing content, the display device may display all context menus related to the content on one screen or may display buttons for displaying the context menus.

In the case where all of the context menus related to the content are displayed on one screen, important information related to the content may be hidden due to a space that is occupied by the content menus. Further, if the number of context menus is large, the space that is occupied by the context menus is increased, and thus, there is a requirement to confirm a content execution screen by using a scroll bar. That is, due to the context menus being displayed, a user should move the scroll bar to confirm the entire content execution screen.

Further, only in the case where a button for displaying the context menu is pressed, does the display device display the context menu related to the content. In the case where the button is not pressed, a user is unable to confirm which context menus are displayed in relation to the content. Thus, the user needs to search for a desired context menu by pressing the buttons one by one.

### SUMMARY

The exemplary embodiments have been made to address at least the above needs and to provide at least the advantages described below, and an aspect of the exemplary embodiments is to provide a display apparatus and a method of displaying a context menu, which enables a user to easily recognize the context menu by displaying an icon capable of identifying the existence of the context menu which is related to content and displaying the context menu included in a focused menu.

According to one aspect of the exemplary embodiments, a method of displaying a context menu of a display apparatus includes displaying a content list including at least one menu; displaying on the menu of the at least one menu a menu identification icon that indicates the existence of the context menu; and in response to any one of the at least one menu being focused, displaying the at least one context menu included in a focused menu, wherein the context menu is a menu for selection of at least one function that can be performed in relation to the menu of the at least one menu.

The method of displaying a context menu according to an aspect of the exemplary embodiments may further include removing the display of the at least one context menu in response to a preset period of time elapsing after any one of the at least one menu is focused.

The method of displaying a context menu according to an aspect of the exemplary embodiments may further include removing the display of the at least one context menu in response to a movement signal in a direction opposite to a direction in which the menu identification icon being displayed in the focused menu is received in a state where the at least one context menu is displayed.

The method of displaying a context menu according to an aspect of the exemplary embodiments may further include again displaying the at least one context menu in response to the movement signal in the same direction as the direction in which the menu identification icon is displayed in the focused menu being received in a state where the at least one context menu is displayed.

A signal for focusing the any one of the at least one menu and the movement signal may be signals that are received according to an input of directional keys provided in a remote controller.

The displaying the at least one context menu may include arranging the plurality of context menus in a vertical direction on one side of the focused menu in response to a plurality of context menus being included in the focused menu.

The displaying the at least one context menu may include displaying the at least one context menu included in the menu of the at least one menu in response to their being a menu including the same context menu as the focused menu in the at least one menu.

The displaying the at least one context menu may include displaying the at least one context menu in a vertical direction with respect to a direction in which the at least one menu is arranged in the content list.

The context menu may be a menu for at least one function of deletion related to the focused menu, execution, execution end, storage, information input, information transfer and edition.

The method for displaying a context menu according to an aspect of the exemplary embodiments may further include executing a function that corresponds to the selected context menu in response to any one menu of the at least one context menu that is displayed on the focused menu being selected.

According to another aspect of the exemplary embodiments, a display apparatus includes a display configured to display a content list including at least one menu; and a controller configured to control the display in order to display a menu identification icon that indicates the existence of the context menu on a menu, and to display the at least one context menu included in a focused menu in response to any one menu of the at least one menu being focused, wherein the context menu is a menu for at least one function that can be performed in relation to the menu of the at least one menu.

The controller may be configured to control the display to remove the display of the at least one context menu in response to a preset time elapsing after any one of the at least one menu is focused.

The controller may be configured to control the display in order to remove the display of the at least one context menu in response to a movement signal in a direction opposite to a direction in which the menu identification icon is displayed in the focused menu being received in a state where the at least one context menu is displayed.

The controller may be configured to control the display in order to again display the at least one context menu in response to the movement signal in the same direction as the direction in which the menu identification icon is displayed in the focused menu being received in a state where the at least one context menu is displayed.

The display apparatus according to the aspect of the exemplary embodiments may further include a remote control signal receiver, wherein the controller is configured to receive a signal to focus the any one menu of the at least one menu or the movement signal in response to a remote control signal being received through the remote control signal receiver according to an input of direction keys provided in the remote control signal receiver.

The controller may be configured to control the display to arrange the plurality of context menus in a vertical direction on one side of the focused menu in response to a plurality of context menus being included in the focused menu.

The controller may be configured to control the display in order to display the at least one context menu included in a menu in response to the corresponding menu including the same context menu as the focused menu in the at least one menu.

The controller may be configured to control the display to display the at least one context menu in a vertical direction compared to a direction in which the at least one menu is arranged in the content list.

The context menu may be a menu for at least one function of deletion related to the focused menu, execution, execution end, storage, information input, information transfer and edition.

The controller may be configured to execute a function that corresponds to a selected context menu in response to any one of the at least one context menu that is displayed on the focused menu being selected.

An aspect of an exemplary embodiment may provide a display apparatus including: a display configured to display a content list including at least one menu; and a controller configured to control the display in order to display a menu identification icon that indicates existence of a context menu, indicate a focus on a menu of the at least one menu based on a received input, and to display the at least one context menu included in the focused menu.

### BRIEF DESCRIPTION OF THE DRAWINGS

The above and other aspects, features and advantages of the exemplary embodiments will be more apparent from the following detailed description when taken in conjunction with the accompanying drawings, in which:

FIG. 1 is a block diagram which illustrates the configuration of a display apparatus, according to an exemplary embodiment;

FIG. 2 is a block diagram which illustrates the configuration of a display apparatus, according to another exemplary embodiment;

FIGS. 3A to 3C are views which explain a method of displaying a context menu, according to an exemplary embodiment;

FIGS. 4A to 4D are views explaining a method of displaying a context menu, according to another exemplary embodiment;

FIGS. 5A to 5D are views explaining a method of displaying a context menu, according to still another exemplary embodiment;

FIGS. 6A and 6B are views explaining a method of displaying a context menu, according to still another exemplary embodiment;

FIGS. 7A and 7B are views explaining a method of displaying a context menu according to still another embodiment of the present disclosure;

FIG. 8 is a flowchart which illustrates a method of displaying a context menu according to an exemplary embodiment; and

FIG. 9 is a flowchart which illustrates a method of displaying a context menu according to another exemplary embodiment.

### DETAILED DESCRIPTION OF THE EXEMPLARY EMBODIMENTS

Hereinafter, exemplary embodiments are described in detail with reference to the accompanying drawings. However, in the following description, a detailed description of known functions and configurations incorporated herein will be omitted when it may obscure the subject matter of the exemplary embodiments.

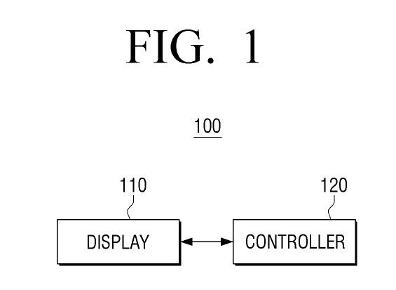

FIG. 1 is a block diagram which illustrates the configuration of a display apparatus according to an exemplary embodiment. Referring to FIG. 1, a display apparatus 100 includes a display 110 and a controller 120.

The display 110 displays a content list that includes at least one menu. Specifically, in response to content being executed, at least one menu for the corresponding content may be displayed in the form of a list, and this is called a content list.

For example, in response to music content being executed to listen to music, one piece of music may be one menu. Accordingly, in response to a plurality of pieces of music existing, a content list including a plurality of menus is displayed.

The content list may include one menu or two or more menus. Hereinafter, it is exemplified that a content list includes a plurality of menus.

The controller 120 controls the entire operation of the display apparatus 100. Further, the controller 120 controls a context menu display operation according to the exemplary embodiments.

In response to a content list being displayed on a screen, the controller 120 controls the display 110 in order to display a menu identification icon that indicates the existence of a context menu on a menu which includes the at least one context menu, among a plurality of menus. In this case, the menu identification icon is an indicator that indicates the existence of the context menu and may have a shape that can be easily recognized by a user, such as a specific form or a text.

In response to any one of the plurality of menus included in the content list being focused, the controller 120 controls the display 110 in order to display the at least one context menu included in a focused menu.

In response to a movement signal in any one of upper, lower, left, and right directions being received from a remote controller in a state where the content list is displayed, a menu that is in a position according to the movement signal is focused. In this case, the controller 120 may control the display 110 in order to automatically display at least one context menu included in a focused menu that is within a focused menu region.

The context menu may be a menu for at least one function that can be performed in relation to the focused menu, such as a shortcut menu or a popup menu. Specifically, the context menu may be a menu for at least one function of deletion related to the focused menu, execution, execution end, storage, information input, information transfer and edition.

For example, in response to the focused menu being one piece of music, menus for “listen”, “transfer”, and “delete” functions, which are related to the music, may be the context menus.

As described above, in the display apparatus 100, according to this exemplary embodiment, the context menus are automatically displayed in response to the focusing of a menu desired by a user, without the necessity of individually selecting menu identification icons from the menus included in the content list, and thus the user can easily recognize the context menus.

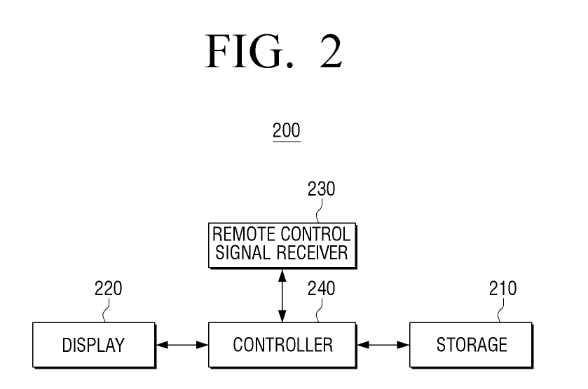

FIG. 2 is a block diagram which illustrates the configuration of a display apparatus according to another exemplary embodiment. Referring to FIG. 2, a display apparatus 200 includes a storage 210, a display 220, a remote control signal receiver 230 and a controller 240.

The storage 210 stores various applications that can be executed in the display apparatus 200. Further, the storage 210 may store various pieces of content that can be provided by the respective applications or may store content server information that makes it possible to use various pieces of content related to the respective applications.

In response to an execution command for a specific piece of content being input, the controller 240 executes the corresponding content. As the content is executed, the display 220 may display a content list.

As described above, the content list may include one menu related to the content or may include a plurality of menus. Specifically, in response to the content being executed, at least one menu for the content which corresponds to the executed content may be display in the form of a list, and this is called a content list. Hereinafter, it is exemplified that the content list includes a plurality of menus.

For example, in response to video call content being executed, contact address information for the video call, that is, a phone book, may be one menu. Accordingly, in response to a plurality of pieces of contact address information existing, a content list including a plurality of menus may be displayed.

The remote control signal receiver 230 receives a specific control signal from the remote controller. Specifically, the remote control signal receiver 230 may receive a power on/off signal of the display apparatus 200, a channel change signal, a volume change signal, and a control signal for operations of the apparatus (e.g., brightness, video effect, sound effect, and on/off, but is not limited thereto), and may also receive operation signals for various UI screens that are displayed on the screen. The operation signals for various UI screens may basically be movement signals in upper, lower, left, and right directions and a selection signal.

The controller 240 controls the whole operation of the display apparatus 200. Further, the controller 240 controls a display operation for a context menu according to an exemplary embodiment.

In response to a content list being displayed on the screen, the controller 240 controls the display 220 to display a menu identification icon that indicates the existence of a context menu on a menu among a plurality of menus.

In response to a movement signal in any one of upper, lower, left, and right directions is received from the remote control signal receiver 230 in a state where the content list is displayed, the controller 240 changes the position of a focused menu on the content list according to the movement signal.

In response to any one menu being focused on the content list according to the movement signal, the controller 240 may control the display 220 to automatically display in a focused menu region at least one context menu included in the focused menu.

That is, in response to any one menu being focused, this means that there is a possibility that any one context menu that is related to the focused menu is selected, and thus the controller 240 may control the display 220 to automatically display the at least one context menu.

On the other hand, the at least one context menu may be displayed in a vertical direction with respect to the direction in which a plurality of menus are arranged in the content list.

For example, in response to the plurality of menus being arranged in a vertical direction in the content list, the at least one context menu included in the respective menus may be displayed in the horizontal direction that is perpendicular to the vertical direction. Accordingly, the region of other menus that are arranged in the vertical direction can be minimized or prevented from being hidden by the at least one context menu.

On the other hand, in response to a preset period of time elapsing after any one menu is focused, the controller 240 may control the display 220 to remove the display of the at least one context menu.

In response to the context menu not being selected during the preset period of time after the at least one context menu is displayed, the controller 240 may determine that there is no possibility that the context menu is selected, and may remove the display of the context menu. Furthermore, by removing the display of the context menu after the preset period of time, the context menu can be prevented from being unnecessarily displayed for a long period of time.

In response to a movement signal in a direction opposite to the direction in which the menu identification icon is displayed in the focused menu being received in a state where the at least one context menu is displayed, even in response to the preset time not elapsing, the controller 240 may control the display 220 in order to remove the display of the at least one context menu.

On the other hand, in response to the preset period of time elapsing or a movement signal in the same direction as the direction in which the menu identification icon is displayed in the focused menu in a state where the display of the at least one context menu is removed according to the movement signal received by the remote control signal receiver 230, the controller 240 may control the display 220 in order to again display the at least one context menu.

In response to a plurality of context menus being included in the focused menu, the controller 240 may arrange the plurality of context menus in the vertical direction on one side of the focused menu. In this case, the plurality of context menus arranged in the vertical direction may be displayed on one side in the focused menu or on one side except for the focused menu.

On the other hand, in response to a menu that includes the same context menu as the focused menu existing in the plurality of menus, the controller 240 may control the display 220 in order to display the context menus included in the corresponding menu. Accordingly, by only focusing any one menu of the plurality of menus, the user can confirm the context menus of other menus having the same context menu as the focused menu, one at a time.

According to the display apparatus 200 as described above, the user can easily recognize the context menus for the respective menus included in the content list. Further, the content list can be prevented from being unnecessarily hidden by the display of the context menus, and thus inconvenience in using the content list can be minimized. Further, in a TB environment where a TV is controlled by a remote control device such as a remote controller, the user can display the context menus through simple operation of the remote controller.

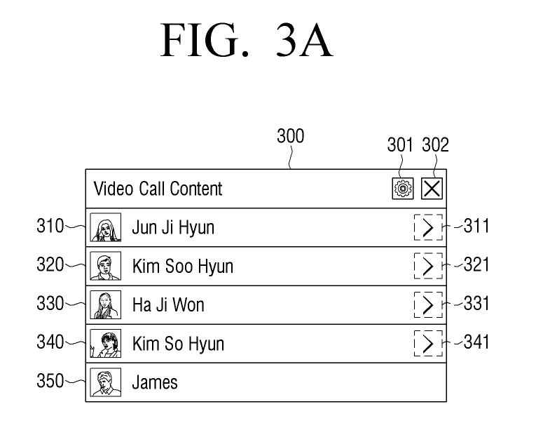

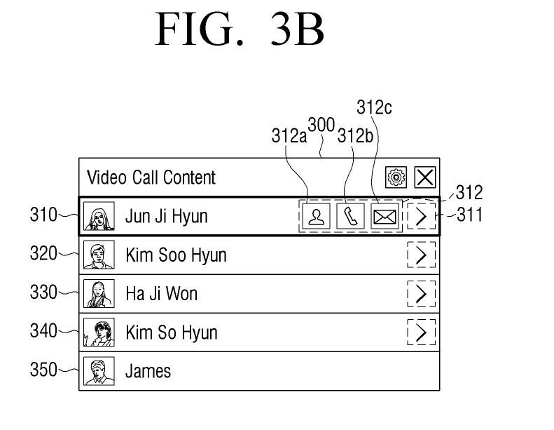

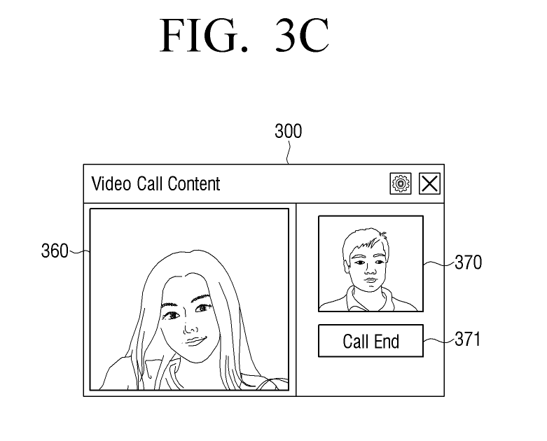

FIGS. 3A to 3C are views which explain a method of displaying a context menu for video call content. As illustrated in FIG. 3A, a video call content execution screen 300 includes a plurality of contact address menus 310, 320, 330, 340 and 350 in the form of a content list, and further includes a first button 301 for setting/changing the environment or attribute of the content execution screen 300 and a second button 302 for cancelling the execution of the video call content.

The plurality of contact address menus 310 to 350 are arranged in the vertical direction of the content execution screen 300. Among the plurality of contact address menus 310 to 350, the first contact address menu “Jun Ji Hyun” 310 on which context menus exist, the second contact address menu “Kim Soo Hyun” 320, the third contact address menu “Ha Ji Won” 330, and the fourth contact address menu “Kim So Hyun” 340 include respective menu identification icons 311, 321, 331 and 341. That is, the first to fourth menu identification icons 311, 321, 331, and 341 may be indicators indicating that the first to fourth contact address menus 310 to 340 have context menus. Accordingly, a user can recognize that the first to fourth contact address menus 310 to 340 have the context menus through the first to fourth menu identification icons 311, 321, 331 and 341.

In contrast, the fifth contact address menu “James” 350 does not include a menu identification icon, and thus the user can recognize that the fifth contact address menu “James” 350 does not have the context menu.

On the other hand, as illustrated in FIG. 3B, in response to the first contact address menu 310 being focused on the content execution screen 300 according to a remote control signal generated through a user operation, three context menus 312a, 312b and 312c, which are function menus that can be performed in relation to the first contact address menu 310, are automatically displayed in the first contact address menu 310.

For example, the three context menus 312a, 312b and 312c may be a video call menu 312a, a general call menu 312b, and a message transfer menu 312c for making a video call with “Jun Ji Hyun” that corresponds to the first contact address menu 310. However, the context menus that can be executed in relation to the first contact address menu 310 are not limited thereto, and further context menus may be included to correspond to additional functions related to the video call content.

As illustrated in FIG. 3B, the three context menus 312a, 312b and 312c are included in the first contact address menu 310, and are displayed in the horizontal direction that is perpendicular to the direction in which the first to fifth contact address menus 310 to 350 are arranged. Accordingly, the three context menus 312a, 312b and 312c can be displayed without being hidden by the second to fifth contact address menus 320 to 350.

In response to the video call menu 312a among the three function menus 312a, 312b and 312c being selected according to the remote control signal generated by the user's operation, the display apparatus can execute a video call with “Jun Ji Hyun” that corresponds to the first contact address menu 310.

Accordingly, as illustrated in FIG. 3C, the content execution screen 300 displays an image 360 of an opposite party who makes the video call and an image 370 of a user of the display apparatus. Further, the content execution screen 300 may further display a call end button 371 for ending the video call.

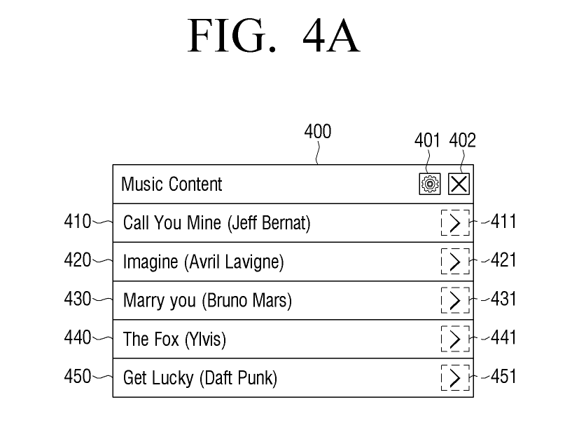

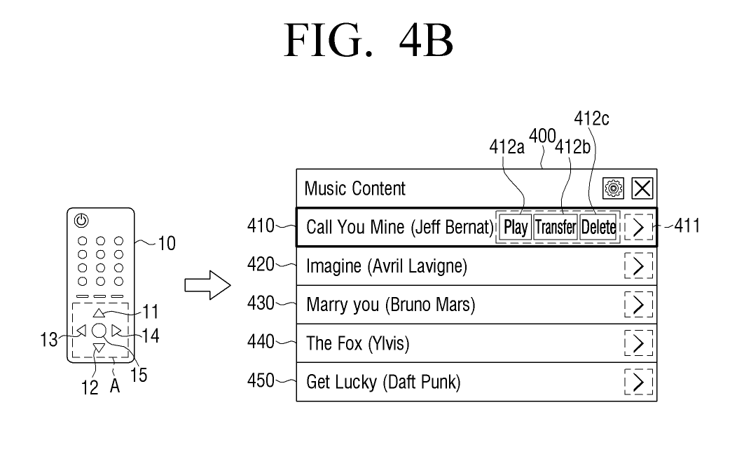

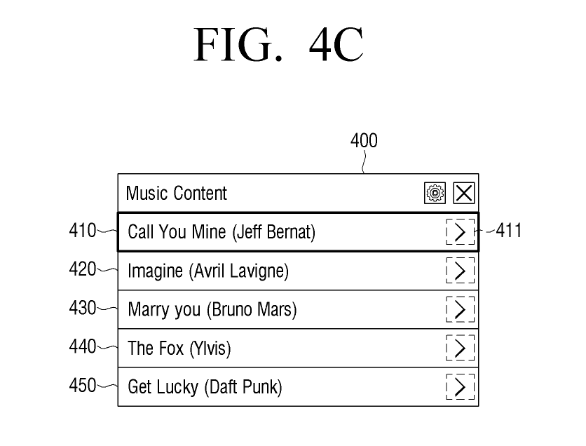

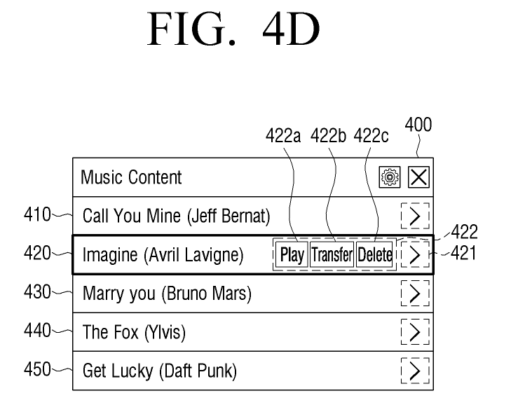

FIGS. 4A to 4D are views which explain a method of displaying a context menu for music content. As shown in FIG. 4A, a music content execution screen 400 includes a plurality of music menus 410, 420, 430 440, and 450 in the form of a content list, and further includes a first button 401 for setting/changing the environment or attribute of the content execution screen 400 and a second button 402 for cancelling the execution of the video call content.

The plurality of music menus 410 to 450 are arranged in a vertical direction of the content execution screen 400. Among the plurality of music menus 410 to 450, the first music menu “Call You Mine” 410 on which context menus exist, the second music menu “Imagine” 420, the third music menu “Marry You” 430, the fourth music menu “The Fox” 440, and the fifth music menu “Get Lucky” include respective menu identification icons 411, 421, 431, 441 and 451.

That is, the first to fifth menu identification icons 411, 421, 431, 441 and 451 may be indicators indicating that the first to fifth music menus 410 to 450 have context menus. Accordingly, a user can recognize that the first to fifth music menus 410 to 450 have the context menus through the first to fifth menu identification icons 411, 421, 431, 441 and 451.

On the other hand, as shown in FIG. 4B, a user may execute functions related to a desired music menu on the content execution screen 400 using direction keys of a remote controller 10.

The remote controller 10 includes four direction keys 11, 12, 13 and 14 that correspond to upper, lower, left, and right directions in a direction key region A, and a selection key 15.

In response to the user pressing the lower direction key 12 once in a state where the content execution screen 400 illustrated in FIG. 4A is displayed on the display apparatus, the first music menu 410 is focused, but is not limited thereto. Any one menu of the first to fifth music menus 410 to 450 may be optionally focused in response to the content execution screen 400 being displayed.

As described above, in response to the first music menu 410 being focused, three context menus 412a, 412b and 412c, which are function menus that can be performed in relation to the first music menu 410, are automatically displayed in the first music menu 410.

For example, the three context menus 412a, 412b and 412c may be a play menu 412a for playing “Call You Mine” that corresponds to the first music menu 410, a transfer menu 412b for transferring a file “Call You Mine” to another person, and a delete menu 412c for deleting the file “Call You Mine.”

In response to a preset period of time (e.g., 10 seconds) elapsing or a movement signal in the opposite direction (e.g., left direction) to the direction (e.g., right direction) in which the first menu identification icon 411 is displayed in the first music menu 410 being received in a state where the content execution screen 400 as shown in FIG. 4B is displayed, the display apparatus, as illustrated in FIG. 4C, removes the display of the three context menus 412a, 412b and 412c that are displayed in the first music menu 410. Accordingly, the first music menu 410 is only in a focused state, but is not in a state where the context menus are displayed.

On the other hand, as shown in FIG. 4D, in response to the user pressing the lower direction key 12 of the remote controller 10 once in a state where the first music menu 410 is focused, the second music menu 420 is focused. In response to the second music menu 420 being focused as described above, three context menus 422a, 422b and 422c, which are function menus that can be performed in relation to the second music menu 420, are automatically displayed in the second music menu 420. The user may then select any one of the three context menus 422a, 422b and 422c to control the functions related to the second music menu 420.

Through this, the user can focus a desired music menu using the four direction keys 11, 12, 13 and 14 of the remote controller 10 and select the context menu included in the focused music menu.

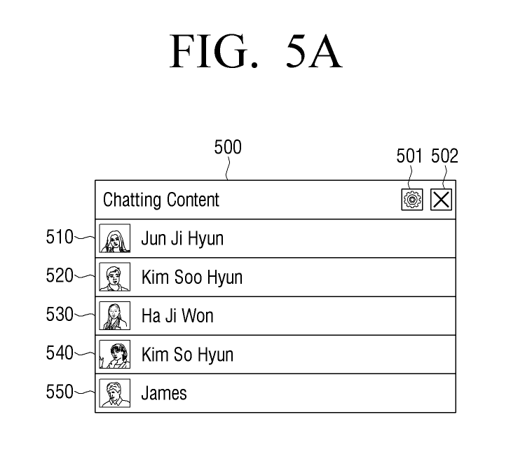

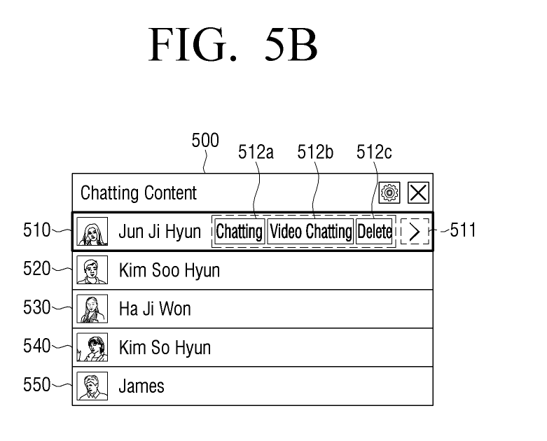

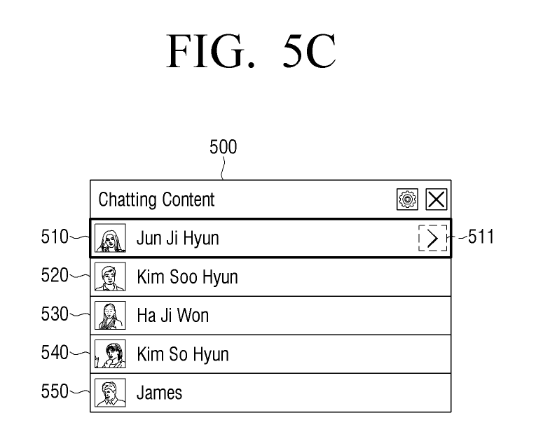

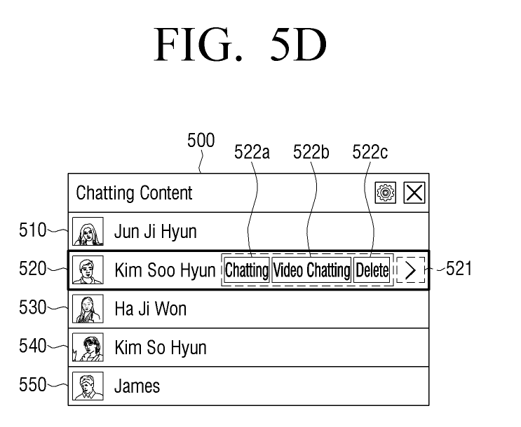

FIGS. 5A to 5D are views which explain a method of displaying a context menu for chatting content. As illustrated in FIG. 5A, a chatting content execution screen 500 includes a plurality of chatting target menus 510, 520, 530, 540 and 550 in the form of a content list. The plurality of chatting target menus 510 to 550 are arranged in the vertical direction of the content execution screen 500.

Further, the content execution screen 500 includes a first button 501 for setting/changing the environment or attribute of the content execution screen 500 and a second button 502 for cancelling the execution of the chatting content.

In response to the content execution screen 500 being displayed according to an execution command for the chatting content, the content execution screen 500 that is initially displayed can display only photos and names (or talk names) of the chatting targets on the plurality of chatting target menus 510, 520, 530, 540 and 550. On the initial content execution screen 500, menu identification icons related to the respective chatting target menus or the context menu is not displayed.

In response to the movement signal in the lower direction being received on the initial content execution screen 500 from the remote controller, as illustrated in FIG. 5B, the first chatting target menu 510 may be focused on the content execution screen 500. As described above, three context menus 512a, 512b and 512c for “chatting,” “video chatting,” and “delete” functions, which can be performed in relation to the first chatting target menu 510, are automatically displayed in the first chatting target menu 510. In this case, the existence of the context menus may be displayed together with the menu identification icon 511. Accordingly, the user may select any one of the three context menus 522a, 522b and 522c to control the functions related to the second chatting menu 520.

On the other hand, the menu identification icon is not necessarily displayed, and in the case where the first chatting target menu 510 is focused, only the three context menus 512a, 512b and 512c, except for the menu identification icon 511, may be displayed.

In response to a preset period of time elapsing after the first chatting target menu 510 illustrated in FIG. 5C being focused, the display of the three context menus 512a, 512b and 512c may be removed. In contrast, the display of the menu identification icon 511 may be maintained even after the preset time elapses.

Further, in response to the menu identification icon 511 not being displayed on the first chatting target menu 510, the display of the three context menus 512a, 512b and 512c may be removed, and the menu identification icon 511 may be displayed in the first chatting target menu 510.

That is, by displaying the menu identification icon 511 while the first chatting target menu 510 is focused, even in response to the display of the three context menus 512a, 512b and 512c being removed, the user can recognize the existence of the context menu through the menu identification icon 511.

On the other hand, in response to a movement signal in the same direction (e.g., right direction) as the direction in which the menu identification icon 511 is displayed being received in a state where the display of the three context menus 512a, 512b and 512c is removed, as illustrated in FIG. 5B, the three context menus 512a, 512b and 512c may be displayed again in the first chatting target menu 510.

In response to a movement signal in the lower direction being received from the remote controller in a state where the first chatting target menu 510 is focused, as illustrated in FIG. 5D, the second chatting target menu 520 is focused on the content execution screen 500.

As described above, in response to the second chatting target menu 520 being focused, the three context menus 522a, 522b and 522c, which are function menus that can be performed in relation to the second chatting target menu 520, and the menu identification icon 521 are automatically displayed in the second chatting target menu 520. Accordingly, the display apparatus does not always display the context menus 522a, 522b and 522c and the menu identification icon 521 on the content execution screen 500, but may display the context menus 522a, 522b and 522c and the menu identification icon 521 only with respect to the menu that the user is concerned with; that is, the focused menu.

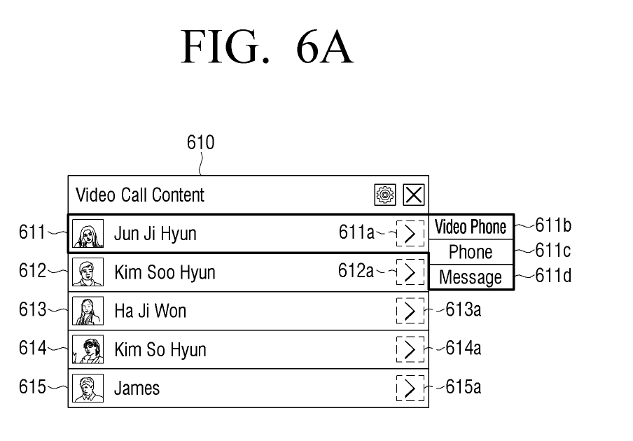

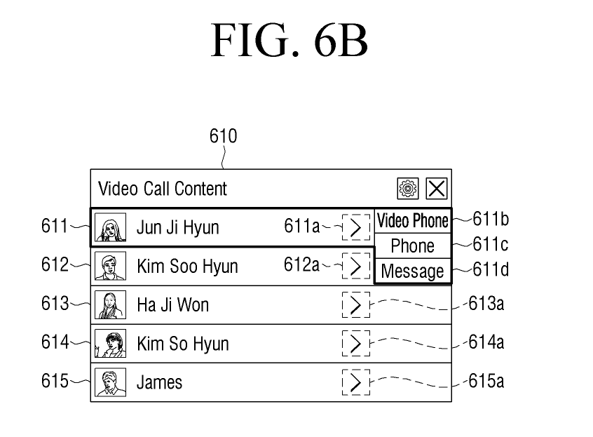

FIGS. 6A and 6B are views which explain a method of displaying a context menu for video call content. As illustrated in FIG. 6A, a video call content execution screen 610 includes a plurality of contact address menus 611, 612, 613, 614 and 615 in the form of a content list.

The plurality of contact address menus 611 to 615 are arranged in the vertical direction of the content execution screen 610, and may include first to fifth menu identification icons 611a, 612a, 613a, 614a and 615a that indicate the existence of the context menus in the respective menu display regions. Accordingly, a user can recognize that the first to fifth contact address menus 611 to 615 have the context menus through the first to fifth menu identification icons 611a, 612b, 613a, 614a and 615a.

On the other hand, in response to the first contact address menu 611 being focused on the content execution screen 610 according to a remote control signal generated through a user operation, three context menus 611b, 611c and 611d, which are function menus that can be performed in relation to the first contact address menu 611, are automatically displayed in the first contact address menu 611. In this case, the three context menus 611b, 611c and 611d may be displayed on one side of the first contact address menu 611.

That is, as illustrated in FIG. 6A, the three context menus 611b, 611c and 611d may be connected to the right side of the first contact address menu 611 to be arranged in a vertical direction. In this case, the context menus are not necessarily arranged in the vertical direction, but may be arranged in the horizontal direction even in response to the display apparatus having a large screen or the context menus that may be arranged in the horizontal direction do not interfere with the display of the content execution screen 610.

FIG. 6A illustrates that the three context menus 611b, 611c and 611d are displayed on one side except for the first contact address menu 611, but are not limited thereto. That is, as illustrated in FIG. 6B, the three context menus 611b, 611c and 611d may be displayed on one side, except for the first contact address menu 611. However, in response to the context menus being displayed as shown in FIG. 6B, a part of the second contact address menu 612 may be hidden by the display of the context menus, and the context menus may be displayed in a limited time.

For example, in response to the context menu not being selected for about 5 to 10 seconds after the first contact address menu 611 is focused in a state where the three context menus 611b, 611c and 611d are automatically displayed, the display of the three context menus 611b, 611c and 611d may be removed.

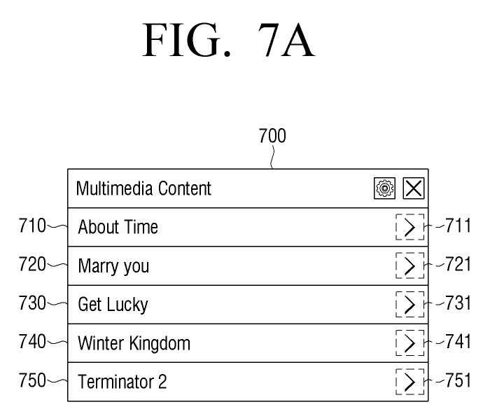

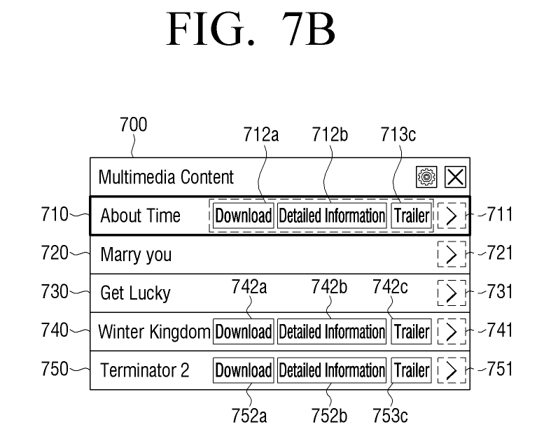

FIGS. 7A and 7B are views which explain a method of displaying a context menu for multimedia content. As shown in FIG. 7A, a multimedia content execution screen 700 includes first to fifth content menus 710, 720, 730, 740 and 750 in the form of a content list. Here, the plurality of content menus 710 to 750 may include multimedia content, such as music content, movie content, game content or drama content.

The first to fifth content menus 710 to 750 may be any one of movie, drama, game and music. For example, the first, fourth, and fifth content menus 710, 740 and 750 may relate to movies, and the second and third content menus 720 and 730 may relate to music.

The first to fifth content menus 710 to 750 include first to fifth menu identification icons 711, 721, 731, 741 and 751 that indicate the existence of the context menus.

On the other hand, as shown in FIG. 7B, if the first content menu 710 is focused on the content execution 700 according to a remote control signal generated by a user's operation, three context menus 712a, 712b and 712c, which are function menus that can be performed in relation to the first contact address menu 710, are automatically displayed in the first content menu 710.

In the same manner, three context menus 742a, 742b, 742c, 752a, 752b and 752c of the fourth and fifth content menus 740 and 750, which include the same context menus as the first content menu 710, may be automatically displayed.

That is, the movie menus 710, 740 and 750 include the same context menus, and thus the display apparatus can automatically display the content menus for the movie menus 710, 740, and 750 even in response to any one of the movie menus 710, 740 and 750 being focused. Accordingly, the user can recognize the context menus for the movie menus 710, 740, and 750 having the same context menus, one at a time.

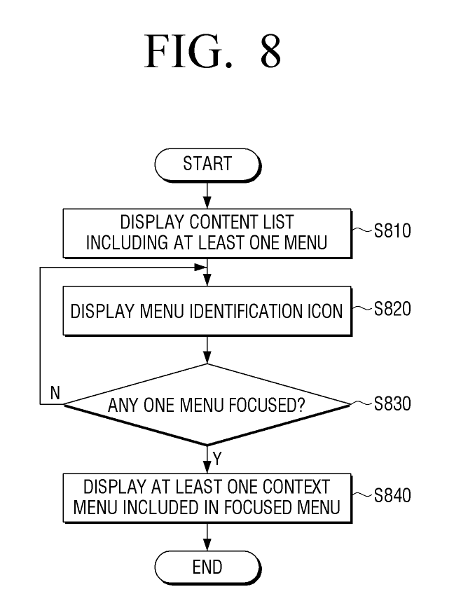

FIG. 8 is a flowchart which illustrates a method of displaying a context menu according to an exemplary embodiment.

In response to a specific content being executed, the display apparatus displays a content list including at least one menu (S810), and displays a menu identification icon on a menu, on which context menus exist, for at least the one menu (S820). The menu identification icon is an indicator that indicates the existence of context menus for at least one function that can be performed in relation to the corresponding menu.

On the other hand, in response to any one of the at least one menu being focused (S830), the display apparatus automatically displays at least one context menu included in the focused menu (S840). In this case, the display apparatus displays at least one context menu in the vertical direction which is the same direction in which the at least one menu is arranged, and thus the context menu does not hide or overlap other menus.

According to the method for displaying a context menu as illustrated in FIG. 8, a user can recognize the existence/nonexistence of the content menu through the menu identification icon, and can confirm the context menu only through focusing of the menu.

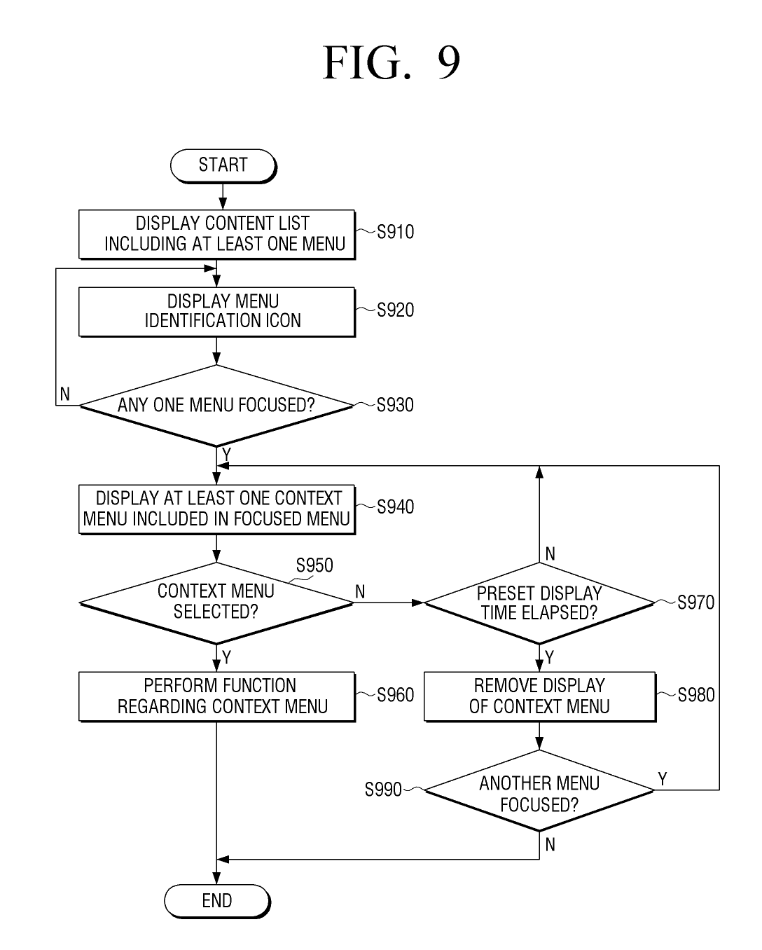

FIG. 9 is a flowchart which illustrates a method of displaying a context menu according to another exemplary embodiment. The method of displaying a context menu illustrated in FIG. 9 may be performed by the display apparatus, and may be used more efficiently in an environment where a remote controller is used.

Referring to FIG. 9, in response to a specific content being executed, the display apparatus displays a content list including at least one menu (S910), and displays a menu identification icon on a menu, on which context menus exist, of the at least one menu (S920).

On the other hand, in response to any one of the at least one menu being focused (S930), the display apparatus automatically displays at least one context menu included in the focused menu (S940).

In response to one of the at least one context menu being selected (S950), the display apparatus executes a function for the selected context menu (S960). For example, in response to the context menu corresponding to a “delete” function, the display apparatus may delete the focused menu file on the menu of the content list.

On the other hand, in response to a preset period of display time elapsing (S970) in a state where the at least one context menu is automatically displayed, the display apparatus removes the display of the context menu (S980).

Thereafter, in response to another menu being focused (S990), the display apparatus automatically displays at least one context menu included in the focused menu (S940). The display apparatus may then execute a function for the context menu according to a user selection.

The method for displaying a content menu as described above may be implemented by a program (or application) including an executable algorithm that can be executed by a computer, and the program may be stored and used in a non-transitory computer readable storage medium.

While the present disclosure has been shown and described with reference to certain exemplary embodiments thereof, it will be understood by those skilled in the art that various changes in form and detail may be made therein without departing from the spirit and scope of the present disclosure, as defined by the appended claims.

What is claimed is:

1. A method of displaying a context menu of a display apparatus, the method comprising:
displaying a content list including at least one menu;
displaying on a menu of the content list a menu identification icon that indicates the existence of the context menu; and
in response to any one menu of the at least one menu being focused, displaying at least one context menu included in the focused menu,
wherein the context menu is a menu for at least one function that can be performed in relation to the menu of the at least one menu on the content list.

2. The method of displaying a context menu as claimed in claim 1, further comprising removing the display of the at least one context menu in response to a preset period of time elapsing after any one menu of the at least one menu is focused.

3. The method of displaying a context menu as claimed in claim 1, further comprising removing the display of the at least one context menu in response to a movement signal in an opposite direction to a direction in which the menu identification icon is displayed in the focused menu being received in a state where the at least one context menu is displayed.

4. The method of displaying a context menu as claimed in claim 3, further comprising again displaying the at least one context menu in response to the movement signal in the same direction as the direction in which the menu identification icon is displayed in the focused menu being received, in a state where the at least one context menu is displayed.

5. The method of displaying a context menu as claimed in claim 3, wherein a signal for focusing the menu of the at least one menu and the movement signal are signals that are received according to an input of direction keys provided in a remote controller.

6. The method of displaying a context menu as claimed in claim 1, wherein the displaying the at least one context menu comprises arranging the plurality of context menus in a vertical direction on one side of the focused menu in response to a plurality of context menus being included in the focused menu.

7. The method of displaying a context menu as claimed in claim 1, wherein the displaying the at least one context menu comprises displaying the at least one context menu included in the menu of the at least one menu, in response to there being a menu including the same context menu as the focused menu of the at least one menu.

8. The method for displaying a context menu as claimed in claim 1, wherein the displaying the at least one context menu comprises displaying the at least one context menu in a vertical direction with respect to a direction in which the at least one menu is arranged in the content list.

9. The method for displaying a context menu as claimed in claim 1, wherein the context menu is a menu for at least one function of deletion related to the focused menu, execution, execution end, storage, information input, information transfer and edition.

10. The method for displaying a context menu as claimed in claim 1, further comprising executing a function that corresponds to the selected context menu in response to any one context menu of the at least one context menu that is displayed on the focused menu being selected.

11. A display apparatus comprising:
a display configured to display a content list including at least one menu; and
a controller configured to control the display in order to display a menu identification icon that indicates existence of a context menu on the menu of the at least one menu, on which at least one context menu exists, and to display the at least one context menu included in a focused menu in response to any one menu of the at least one menu being focused,
wherein the context menu is a menu for at least one function that can be performed in relation to the menu of the at least one menu.

12. The display apparatus as claimed in claim 11, wherein the controller is configured to control the display to remove the display of the at least one context menu in response to a preset period of time elapsing after any one menu of the at least one menu being focused.

13. The display apparatus as claimed in claim 11, wherein the controller is configured to control the display in order to remove the display of the at least one context menu in response to a movement signal in a direction opposite to a direction in which the menu identification icon is displayed in the focused menu being received in a state where the at least one context menu is displayed.

14. The display apparatus as claimed in claim 13, wherein the controller is configured to control the display to again display the at least one context menu in response to the movement signal in the same direction as the direction in which the menu identification icon is displayed in the focused menu being received in a state where the at least one context menu is displayed.

15. The display apparatus as claimed in claim 13, further comprising a remote control signal receiver,
wherein the controller is configured to receive a signal for focusing the any one menu of the at least one menu or the movement signal in response to a remote control signal according to an input of direction keys provided in a remote controller being received through the remote control signal receiver.

16. The display apparatus as claimed in claim 11, wherein the controller is configured to control the display in order to arrange the plurality of context menus in a vertical direction on one side of the focused menu in response to a plurality of context menus being included in the focused menu.

17. The display apparatus as claimed in claim 11, wherein the controller is configured to control the display in order to display the at least one context menu included in a menu in response to the menu of the at least one menu including the same context menu as the focused menu in the menu of the at least one menu.

18. The display apparatus as claimed in claim 11, wherein the controller is configured to control the display in order to display the at least one context menu in a vertical direction with respect to a direction in which the at least one menu is arranged in the content list.

19. The display apparatus as claimed in claim 11, wherein the context menu is a menu for at least one function of deletion related to the focused menu, execution, execution end, storage, information input, information transfer and edition.

20. The display apparatus as claimed in claim 11, wherein the controller is configured to execute a function that corresponds to a selected context menu in response to any one of the at least one context menu that is displayed on the focused menu is selected.

21. A display apparatus comprising:
a display configured to display a content list including at least one menu; and
a controller configured to control the display in order to display a menu identification icon that indicates existence of a context menu, indicate a focus on a menu of the at least one menu based on a received input, and to display the at least one context menu included in the focused menu.
